(19) United States
(12) Patent Application Publication
(10) Pub. No.: US 2016/0151852 A1
(43) Pub. Date: Jun. 2, 2016

(54) WELDING CONTROL METHOD AND CONTROL APPARATUS

(71) Applicant: PROTOMET SÄRKINIEMI T:MI, Kaarina (FI)

(72) Inventor: Veijo SÄRKINIEMI, Kaarina (FI)

(21) Appl. No.: 14/894,116

(22) PCT Filed: May 29, 2014
(86) PCT No.: PCT/FI2014/000008

§ 371 Date: Nov. 25, 2015

(30) Foreign Application Priority Data
May 29, 2013 (FI) 20130150
Jan. 21, 2014 (FI) 20140016

(51) Int. Cl. B23K 9/10

(52) U.S. Cl. CPC B23K 9/1031; B23K 9/1006

(57) ABSTRACT

Welding control method and control apparatus, by means of which the welding current is controlled during welding such that the temperature of the weld joint and/or component to be welded remains as close as possible to the same temperature. The welding current is reduced evenly and linearly or the welding current is controlled continuously according to any variable function or curve. The welding current can also be controlled gradually or in appropriate steps in the desired direction.

### OBJECT OF THE INVENTION

The object of the invention is a method for controlling welding.

### PRIOR ART

When welding with known methods, the temperature in the weld joint tends to rise. The rise in temperature has many detrimental effects on both the weld joint itself and the crystal structure and strength of the components to be welded. The most visible drawback of the rise in temperature in the weld joint is the fact that the joint surface drops continuously and the joint becomes lower as the temperature rises. At some point, the temperature in the weld joint rises so high that the joint surface also becomes too low, in which case the joint quality is no longer acceptable. In this case, the component also becomes too hot next to the weld joint, whereby cracking and hot cracks occur in the component. In order to avoid problems and to obtain an acceptable weld joint, in such a situation the welder has no other option than to interrupt the welding and to let the spot to be welded cool down sufficiently. Only after that can the welding be continued again so that it is possible to obtain an acceptable joint.

### METHOD

The purpose of this invention is to create a welding method that overcomes the above-mentioned drawbacks. The method according to the invention is characterized in what has been presented in the characteristics section of claim 1. According to the invention, the temperature of the weld joint and/or component to be welded is controlled during welding by controlling the electric power to be used in welding. The electric power to be used in welding is controlled such that the welding current or welding voltage is controlled, or that both the welding current and voltage are controlled simultaneously. When the electric power is controlled so that, for example, the welding current is maintained at a suitable level, the temperature in the weld joint and/or in the component to be welded does not become too high.

According to the invention, the welding current, for example, is controlled during welding such that the temperature of the weld joint and/or component to be welded remains constant or as close as possible to the same temperature, such that the joint becomes as consistent as possible and acceptable in terms of quality throughout. Most advantageously, the welding current is controlled during welding, based on the temperature of the weld joint and/or component to be welded, such that the welding current is reduced if the temperature of the weld joint and/or component to be welded rises.

When controlling the electric power used in welding, the welding current can be controlled in many different ways, such that the welding current controls the temperature of the weld joint and/or component to be welded and the quality of the weld joint. The welding current control can thus be continuous, such that the welding current is reduced evenly and linearly during welding as a function of time. However, the welding current can also be controlled in a continuous manner according to any variable function or curve, such that the welding current decreases when required and, in some cases, also increases.

However, the change in the welding current does not always need to be continuous or even, because the welding current control can also be realised such that the change in the welding current during welding occurs in gradual or appropriate steps in the desired direction. If the magnitude of the steps is reduced and the change frequency is increased when controlling the welding current, at some point even a gradual control method will correspond to an even, continuous control method.

According to the invention, the welding current control can simply be made such that the control apparatus or the welding apparatus itself reduces the welding current for a predetermined time. The decrease in the welding current can then also be determined in advance, such that the welding current changes linearly from the start value to the end value during a predetermined time period. The time period can be, for example, approximately the time required to weld with one welding electrode when welding. Thereby the welding current changing time used in metal arc welding can be, for example, approximately 60 seconds. The welding time can also be shorter, if the joint is so short that it does not require an entire welding electrode. However, particularly when using another welding method, the welding current changing time can also be a lot longer, for example up to 500 seconds. What is essential is that the welding current is reduced during the welding of the weld joint. The length of the joint to be welded can be used to determine the time period during which the welding current is reduced. In this case, the time used for welding is not directly decisive. However, as the method according to the invention can also be used to weld very long joints and the joint can also be welded in one go from start to finish, the length of the weld joint does not, in this case, determine how the welding current is changed. When welding long joints and when the welding of the joint takes a relatively long time, it is essential that the reducing of the welding current is started immediately or at least quite soon after the welding has started. However, when welding a long joint, it is not necessary to reduce the welding current continuously during the welding of the entire joint. What is essential is that the reduction of the welding current takes place at least at the initial phase of continuous welding. Once the welding current has been reduced so much that it has reached a suitable level, the current can be maintained constant as long as the welding arc is in operation.

The reduction in the welding current during the time period used for the reduction can be, for example, 10%-20%, or even 50%, but it can also, in some cases, be smaller or greater than these values. To reduce the welding current, a method can be used whereby the welding current is reduced either evenly or according to a curve determined by a specific function during a predetermined time period. In the example cases, this time period can be, for example, 60-500 seconds. Thereby the welding current is reduced, for example, from a predetermined start value to a predetermined end value according to the type of the component or the thickness of the sheet to be welded. For example, with a 1-mm steel sheet, the start current can be 40 A and the end current 35 A-30 A and with a 10-mm steel sheet, the start current can be 140 A and the end current 130 A-120 A. With thicker steel components, the start value can be, for example, up to 230 A and the end value 180 A. It can be seen from the examples presented above that the welding current is most advantageously reduced by 15-35%. The welding current cannot, however, be reduced more than specified in the guidelines generally used in various welding situations.

For example, if the indicative welding current specified by the welding electrode manufacturer is 90 A-140 A, the welding current can be set to be controlled, for example, such that the starting current is 135 A. After that the welding current decreases, for example, during 60 seconds, evenly down to the value of 90 A. If the welding still continues uninterrupted after 60 seconds, the welding current is maintained at the value of 90 A until the end of the welding operation. This procedure substantially reduces imperfections in the weld joint compared to welding performed in the known manner where the welding current remains essentially the same. According to the invention, it is also possible to additionally use a temperature measuring apparatus, if required, such as a temperature sensor, which allows the welding current to be controlled with even greater accuracy such that the temperature of the component in conjunction with the weld joint remains sufficiently low and as even as possible.

The method according to the invention provides the excellent advantage that the weld joint can be produced in longer cycles or even completely uninterrupted. While the quality of the weld joint improves, the total time required for the welding operation decreases, as there is no need to interrupt the welding and wait for the component to cool down. The drawback with known welding methods has been that the component to be welded easily warms up too much. As many metals are not allowed to get too hot, it has been necessary, when using known methods, to repeatedly interrupt the welding and wait for the component to be welded to cool down.

According to the invention, the value of the welding current can also be set to return to its start value always when the welding of a joint is completed or when the welding electrode ceases to burn. After that, when the welding is started again, the welding current will decrease again in the desired manner. The welding current decrease rate can be maintained the same, but another possibility is to adjust the welding current decrease rate separately each time, especially when the joints to be welded are different in length.

The method according to the invention for reducing the welding current during welding is particularly well-suited to be used in metal arc welding and in TIG welding, but the method can also be used in other welding methods and in robot welding. The problem with known robot welding methods is that a long-lasting welding action excessively heats up the component to be welded. One example where problems have occurred in practice is coating welding performed around a shaft or a pipe. In this case, the shaft rotates or the welding apparatus rotates around the shaft, whereby the shaft or pipe heats up excessively, whereby detrimental metal cracking and hot cracks are caused by the heat brought into the component during welding. When, according to the invention, the welding current is reduced, these problems can be avoided. What is essential according to the invention is that, by reducing the welding current, the amount of heat brought into the component during welding can be minimised. This also makes it possible to keep the difference in temperature between the weld joint and the component as low as possible, thereby avoiding the above-presented problems inherent in known welding methods.

The method according to the invention can be used in almost all welding methods, such as metal arc welding, where no protection gas is required and the coating of the electrode forms a sufficient layer in the joint to protect it from oxidation. The method is also well-suited for use with TIG welding machines equipped with an electrode, using protection gas and filler metal. The filler metal can be in the form of suitably long pieces of metal wire that are fed manually to the joint, or in the form of continuous wire from a reel. The method can also be used in MIG and MAG equipment.

The method according to the invention can also be used in tacking of welds. Thus, the time used for continuous welding can be, for example, in the range of 1 second-2 minutes and the change in the welding current or welding power for example 5%-50%. In tacking, the most advantageous procedure is to start at the electrode's lower limit, where the appropriate welding current is, for example, 90 A, after which the welding current drops to, for example, a value of 60 A.

### CONTROL APPARATUS

The object of the invention is also a control apparatus for controlling welding. The control apparatus according to the invention is characterised in what has been presented in the characteristics section of the independent claim 1 that characterises the control apparatus. The control apparatus according to the invention is, for example, a separate control apparatus to be attached to the welding apparatus or a control apparatus incorporated in the welding apparatus, which, during welding, controls the electric power to be used in welding in order to control the temperature of the weld joint and/or component to be welded. However, the control apparatus can also be a computer program located in a computer unit. In this case, this computer unit can be located in a separate auxiliary device to be connected to the welding machine or in the welding machine itself. The control apparatus can also be a computer program or part of a computer program that is located in a computer unit that has been pre-installed in the welding machine for also controlling other operations of the welding machine.

The control apparatus can be arranged to control the welding current and/or the welding voltage of the welding apparatus during welding. Most advantageously, the control apparatus controls the welding power such that the welding current of the welding apparatus changes from the start value to the end value during a predetermined time period, in which case the time period is, for example, 1 second-2 minutes, most advantageously about 60 seconds, but up to 500 seconds if needed. The welding current decreases, for example, 5%-50%, most advantageously 10%-20%.

Where the control apparatus has been made into a separate apparatus, it can be attached to replace an electric welding apparatus's remote control apparatus that can be used to control the welding current of the welding apparatus. The apparatus according to the invention controls the welding current for example such that the welding current most advantageously changes, linearly or otherwise, from the start value to the end value during a predetermined time period or during the time period used for welding. At its simplest, the time period can be, for example, some 60 seconds or approximately the time required to weld with one welding electrode when welding, but the welding time can also be shorter, for example if the joint to be welded is short. The decrease in welding current during this time period can also vary.

The control apparatus may include an infrared sensor or similar temperature-measuring apparatus, which, during welding, controls the welding current based on the temperature of the weld joint and/or component to be welded, so that the welding current decreases when the temperature of the weld joint and/or component to be welded rises.

According to the invention, the operation of the welding control apparatus can be activated, for example, manually, such that the start button of the control apparatus is pushed in conjunction with the starting of the welding. However, the pushing of the button does not need to occur exactly simultaneously with the starting of the welding. Alternatively, the control apparatus starts to operate automatically when welding is started. When the operation of the control apparatus is made automatic, the operation of the control apparatus can be programmed to operate with the help of a computer or a processor, for example. In this case, the control apparatus can be programmed to take into account, for example, tackings, interruptions and longer uninterrupted welding processes. Various sensors, such as a temperature sensor and/or a motion sensor, that control the computer can then be attached to the control apparatus.

One example of an apparatus according to the invention is a control apparatus that can be connected to a welding machine equipped with an auxiliary device option. To some welding machines, it is possible to connect, with a cable, a manual control apparatus to control the intensity of the welding current. It is easy to replace such an auxiliary apparatus with an apparatus according to the invention. A welding current intensity display located in the welding machine is not necessary, because the apparatus according to the invention can be equipped with a display showing the intensity of the current.

The apparatus according to the invention also includes another cable that is equipped with the welding machine's earth current detector. The earth current detector is, for example, a coil that is placed around the welding machine's earth current cable. Thanks to the detector, the apparatus according to the invention detects when the welding arc is in operation. The example apparatus according to the invention has a display device and operating switches, such as push-buttons. The switches are the welding start current, the welding end current, the welding current increase, the welding current reduction, the time increase and the time reduction. Thanks to the apparatus, it is possible to adjust in advance how much the apparatus will reduce the welding current during a predetermined time after the welding has been started.

The apparatus is adjusted such that the welding start current value is selected first by pushing either the welding current increase or the welding current reduction switches. When the desired start current value in amperes is visible on the display of the apparatus, it is locked by pushing the start current switch. The welding end current is determined in a similar way. After that, the time period during which the welding current is reduced is determined. For that, either the time increase or time reduction switches are pushed continuously. When the desired time period value in seconds is visible on the display of the apparatus, it will remain in the memory of the apparatus. When welding is started, the apparatus reduces the welding current from the predetermined start current to the end current during the predetermined time period. If, for some reason, the welding is interrupted before the end current is reached and has to be started again, the apparatus returns the welding current of the welding machine to the start current value and the welding current decrease begins from the start in the same way until the end current value has been reached. If welding continues even after that, the apparatus keeps the welding current constant at the predetermined end current value.

In the following, the invention is described using examples with reference to the appended drawings, in which

### LIST OF FIGURES

FIGS. 1-6 schematically show examples of the controlling method according to the invention.

### DESCRIPTION OF THE FIGURES

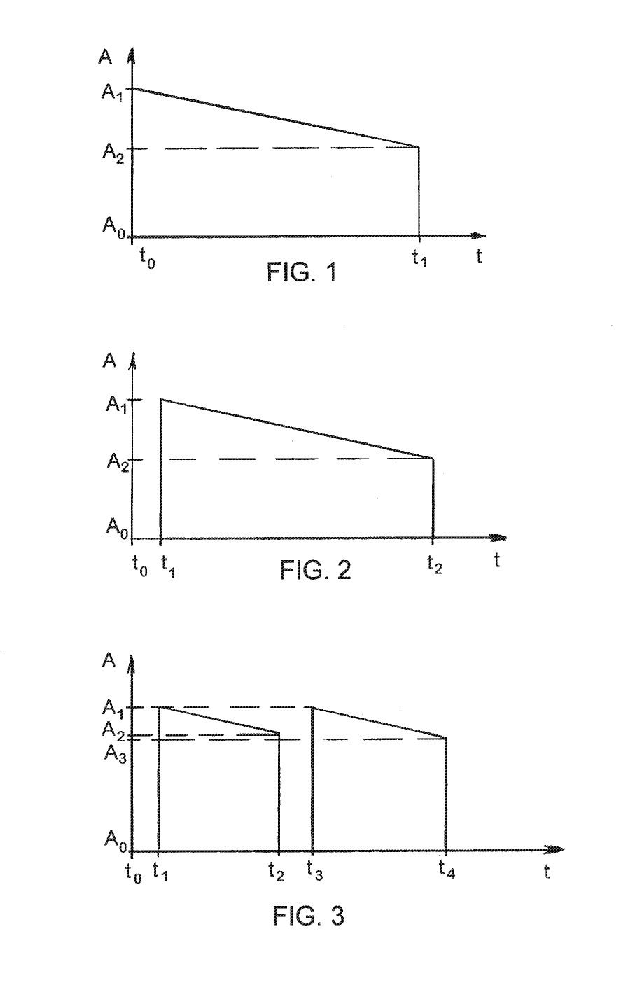

FIG. 1 shows a diagram, where the welding current A is on the vertical axis and time t is on the horizontal axis. In the example of FIG. 1, the value of the welding current A at the welding starting time t₀ is A₁. According to the invention, the welding current is linearly reduced during welding as a function of time such that the value of the welding current at the stopping time t₁ is A₂. In this example, a control apparatus has been used to start the controlling of the welding current at the same time as the welding is started. The control apparatus can be a separate control apparatus to be connected to the welding machine, but it can also be a control apparatus part to be added to control equipment already included in the welding machine. In this case, the separate control apparatus or the control apparatus contained in a computer can have a computer unit, the program of which performs the desired function. It is also possible that a program part that enables the operation according to the invention has been programmed and connected to the computer program used to control the operation of the welding machine.

FIG. 2 shows a similar diagram as FIG. 1, but in this case the control apparatus only starts at the desired time t₁. This time can be determined, for example, such that the welding is started manually by pushing the start button of the control apparatus. In FIG. 2, it can be seen that the welder has not started the control apparatus at exactly the same time t₀ as the welding has been started. As a result of this, the control apparatus only starts at the time t₁ and stops when the welding is stopped at the time t₂. In practice, the time difference between t₀ and t₁ is in general not necessary, and it has little significance for the end result of the welding and the quality of the weld joint.

FIG. 3 shows a diagram, where the welding has been interrupted. The first welding phase is within the time range t₁-t₂ and the second phase between t₃ and t₄. In the starting situation t₁ of the first welding phase, the welding current is A₁ and decreases during welding such that it is A₂ when the welding is interrupted at the time t₁. When the second welding phase is started at the time t₃, the welding current is again the same as in the beginning of the first phase, i.e. A₁, and drops to the value A₃ when this phase ends at the time t₄. Most advantageously, the control method is adjusted such that if the welding is interrupted in between or if it has to be interrupted momentarily, the welding current will, when the next welding sequence begins, return to the same start value as when starting the first welding sequence. The weld joint and the component to be welded cool down during this pause, in which case a higher welding current can be used at the start.

In known welding methods, interrupting the welding and cooling down the component to be welded, sometimes even for long periods of time, is often even unavoidable. In the welding method according to the invention, the mandatory interruption of the welding is however not necessary, as the excessive heating of the component to be welded is prevented by reducing the welding current in the desired manner during welding.

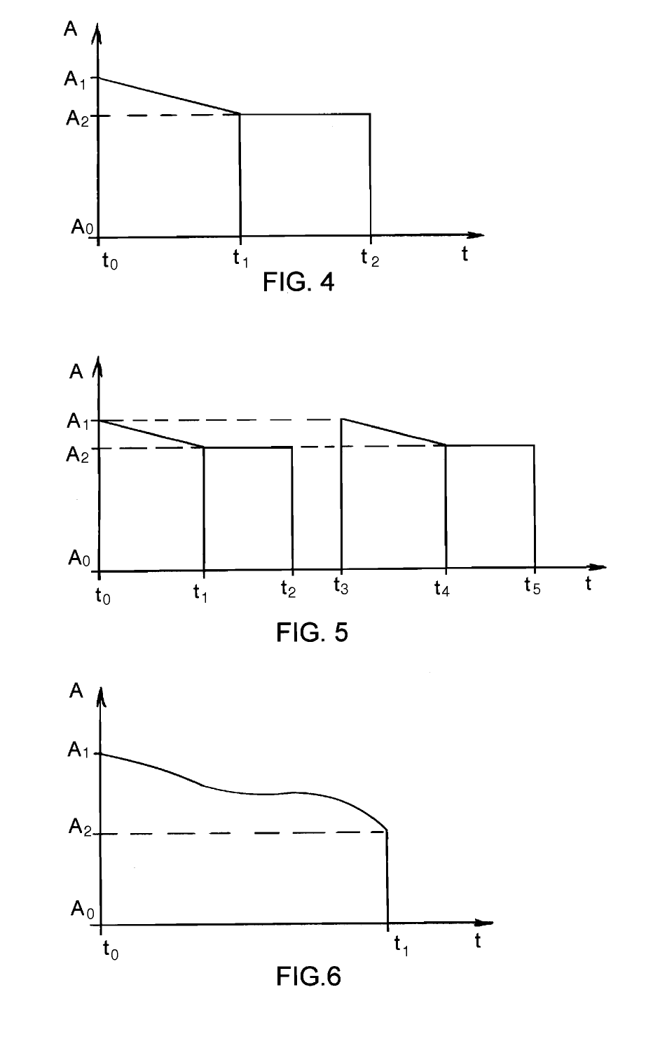

FIG. 4 shows a diagram, where the welding current drops in the first welding phase within the time range t₀-t₁, in the same way as in the figures shown above, from the welding current value A₁ to the value A₂. In this example, the welding continues, however, further during the time range t₁-t₂, in which case the welding current A₂ is sufficient and it does not need to be reduced any further. This is due to the fact that, using the welding method according to the invention, welding can be continued uninterrupted for long periods of time without the component to be welded heating up excessively, which is not possible with known welding methods. The invention substantially increases the efficiency and speed of welding operations. When welding errors resulting from excessive heating of the component to be welded are eliminated at the same time, welding quality also substantially improves. As very long uninterrupted welds are now possible, it is clear that the welding current cannot be reduced endlessly during welding. In practice, welding guidelines determine the lower limit for the welding current, whereby, according to the invention, in long continuous welding, the welding current is maintained constant after the current reduction taking place at the initial phase of the welding.

FIG. 5 shows schematically the situation when welding a very long joint. At the initial phase of the welding, in the time range t₀-t₁, the welding current decreases from the value A₁ to the value A₂. When the welding continues further during the time range t₁-t₂, the welding current A₂ is sufficient and it does not need to be reduced any further in order to obtain a good weld joint and to avoid problems resulting from the possible excessive heating of the component to be welded. In this case, the welding current stays continually at the value A₂. At this welding current value A₂ even a long joint can very well be welded all the way without the problems of known methods.

If, for some other reason, the welding is, however, interrupted at the time t₂, as is shown schematically in FIG. 5, and the welding is continued after a short time at the time t₃, the welding current of the new start is, according to the method according to the invention, again A₁, i.e. the same as when the first welding sequence started at the time t₀. After that, during the time period t₃-t₄, follows the same decrease in the welding current from the value A₁ to the value A₂ as occurred in the first time range t₁-t₂. The time ranges t₁-t₂ and t₃-t₄ can be of equal length, but they can also be of different length. Because it is possible that the component to be welded has, when welding during the time range t₁-t₂, already heated up so much that the welding current can be reduced more quickly to its minimum value A₂ in the second time range t₃-t₄. After the interruption, restart and reduction of the welding current, the end phase of the joint welding in the time range t₄-t₅ is welded at the welding current value A₂.

FIG. 6 shows yet another diagram where the decrease of the welding current does not take place linearly in the time range t₀-t₁. It can basically take place according to any function. In this case, the magnitude of the welding current A may be influenced by, for example, a temperature sensor attached to the control apparatus. When using one or several temperature sensors that are capable of measuring the temperature distribution of the component to be welded in the zones close to the weld joint, the welding current can be reduced and/or controlled stepwise or also continuously such that no detrimental metal cracking and hot cracks occur in the component as a result of the heat brought into the component.

1-12. (canceled)

13. A welding control method, wherein the method comprises reducing a welding current for a predetermined time during the welding of a weld joint, wherein the predetermined time is based on the length of the joint to be welded.

14. The welding control method according to claim 13, wherein the welding current is reduced evenly and linearly as a function of time.

15. The welding control method according to claim 13, wherein the welding current is controlled continuously according to any variable function or curve.

16. The welding control method according claim 13, wherein during welding, the welding current is controlled in gradual steps in the desired direction.

17. The welding control method according to claim 13, wherein the predetermined time is 1 second-500 seconds.

18. The welding control method according to claim 17, wherein the predetermined time is 1 second-2 minutes.

19. The welding control method according to claim 13, wherein the welding current decreases 5%-50%.

20. The welding control method according to claim 19, wherein the welding current decreases 10%-20%.
